(19) United States
(12) Patent Application Publication
(10) Pub. No.: US 2026/0112158 A1
(43) Pub. Date: Apr. 23, 2026

(54) METHODS AND SYSTEMS FOR OBJECT RECOGNITION

(71) Applicant: HITACHI, Ltd., Tokyo (JP)

(72) Inventors: Jie HU, Northville, MI (US); Nobutaka KIMURA, Holland, MI (US)

(21) Appl. No.: 18/922,523

(22) Filed: Oct. 22, 2024

(51) Int. Cl. G06V 10/98; G06V 10/44

(52) U.S. Cl. CPC G06V 10/993; G06V 10/44; G06V 2201/06

(57) ABSTRACT

Systems and methods for an object recognition system, can involve detecting contours from data measurements of one or more objects provided by one or more vision sensors; detecting concavities of the contours of the one or more objects; evaluating correctness of each of the concavities; executing an action for the each of the concavities based on the evaluated correctness to produce revised contours, the action selected from one of keep, complete, or remove; and executing an object recognition process on the revised contours.

### BACKGROUND

### Field

The present disclosure is generally directed to object recognition systems, and more specifically to object recognition in industry and logistics systems.

### Related Art

Object recognition is an important computer vision problem. Object recognition techniques are widely used in industry, such as in warehouse automation, logistics, and retail. Common applications that use object recognition include bin picking, piece picking, palletizing, depalletizing, and so on.

One key information for object recognition is the object contour (object edge, boundary, and contour are used interchangeably in most cases). Many object recognition methods using object contours have been developed, including both learning-based and rule-based techniques. However, it is not uncommon for the detected contours to have issues, for example, incomplete edges, redundant edges, and so on. Thus, it can be desirable to identify such issues and modify contours to improve object recognition performance. However, current object contour detection methods are evaluated on pixel-level accuracy, and researches are focusing on improving the methods by, for example, designing new neural networks, instead of identifying the issues of contours and improving the contours.

### SUMMARY

Problematic object contours have caused recognition errors in the development of a mixed Stock Keeping Unit (SKU) depalletizer. For example, multiple objects may be falsely recognized as one, or one object may be falsely recognized as two. Motivated to solve these issues, the example implementations focus on how to evaluate the correctness of object contour's geometric shape.

In object recognition, the detected object contours (e.g., from edge/boundary detection) may not have the correct geometries. However, detected contours directly affect object recognition accuracy. FIG. 1 provides two examples of detected object contours. As shown in FIG. 1, the solid black contours are the ground truth and the dashed line contours are detected. The image on the left may have correct recognition even though the detected contour has a redundant line. The image on the right may falsely recognize the two objects as one due to the incomplete boundary in the middle.

These two contours are similar in geometry, but should have different correctness because the object recognition results are affected differently. The left contour should be considered relatively good while the contour on the right should be regarded as a bad contour. Thus, there is a need for methods for evaluating the contours to determine whether the detected contours would be correct or not.

The correctness of the object contour's geometric shape should be determined by whether the contour could lead to correct object recognition. Current pixel level evaluation methods from edge/boundary detection are not suitable for evaluating contours in object recognition. FIG. 2 illustrates such an example, indicating that pixel level accuracy of the detected contour is not a suitable indicator of whether the contour could lead to correct object recognition, and that the correctness of object contour's geometric shape is more important than the pixel level accuracy in object recognition. As shown in FIG. 2, the pixel level accuracy (the overlap) between the detected contour (dashed line) and the ground truth (solid) is not high, but the object recognition using the detected contour might be correct. Thus, there is a need for other methods that can evaluate whether correct object recognition can be derived from the contours.

When the evaluation result is not sufficient, there is a need to modify the detected contours to improve the contour quality and object recognition accuracy. One example of the “modification” is to change the contour from the left image to the right image in FIG. 3 by completing the incomplete line.

Notice that the modification shown in FIG. 3 is not always suitable unless the goal is to create convex polygons. For example, if the modification in FIG. 3 is applied to the object in the left image in FIG. 1, the object would be falsely recognized as two. Thus, it can be important to determine the suitable modification for each object contour.

The geometries of the object contours contain important information for both evaluating and designing methods to improve the contours. Concavity is one such geometric attribute that will be leveraged in the example implementations described herein. Further, the statistics of the concavities are found useful to classify objects. The object class information can be further used to design criteria for concavity evaluation and modification. Whether and how the contour is modified to obtain the correct object recognition are based on the evaluation of the contour and concavities.

Example implementations described herein involve an object recognition system that measures the objects using a vision sensor, detects the contours of objects using the measured data, detects the concavities of the object contours, evaluates the correctness of each concavity based on at least one of the proposed criteria, determines an action for each concavity based on the correctness, the actions include at least one of: keep, complete, remove the concavity, or recognizes the objects using the contours.

Example implementations can further include an object recognition system that measures the objects using a vision sensor, detects the contours of objects using the measured data, detects the concavities of the object contours, evaluates the quality of each contour using the concavities, recognizes the objects using the contours, determines at least one action for each recognized object based on the contour quality, the actions include at least one of: direct pick-up, Slight Displacement, or update the statistics of the recognition.

Aspects of the present disclosure include a method for an object recognition system, which can include detecting contours from data measurements of one or more objects provided by one or more vision sensors; detecting concavities of the contours of the one or more objects; evaluating correctness of each of the concavities; executing an action for the each of the concavities based on the evaluated correctness to produce revised contours, the action selected from one of keep, complete, or remove; and executing an object recognition process on the revised contours.

Aspects of the present disclosure include a computer program for an object recognition system, which can include instructions involving detecting contours from data measurements of one or more objects provided by one or more vision sensors; detecting concavities of the contours of the one or more objects; evaluating correctness of each of the concavities; executing an action for the each of the concavities based on the evaluated correctness to produce revised contours, the action selected from one of keep, complete, or remove; and executing an object recognition process on the revised contours. The computer program and instructions can be stored on a non-transitory computer readable medium and executed by one or more processors.

Aspects of the present disclosure include an object recognition system, which can include means for detecting contours from data measurements of one or more objects provided by one or more vision sensors; means for detecting concavities of the contours of the one or more objects; evaluating correctness of each of the concavities; means for executing an action for the each of the concavities based on the evaluated correctness to produce revised contours, the action selected from one of keep, complete, or remove; and means for executing an object recognition process on the revised contours.

Aspects of the present disclosure include an apparatus configured to facilitate an object recognition system, which can include a processor, configured to detect contours from data measurements of one or more objects provided by one or more vision sensors; detect concavities of the contours of the one or more objects; evaluate correctness of each of the concavities; executing an action for the each of the concavities based on the evaluated correctness to produce revised contours, the action selected from one of keep, complete, or remove; and execute an object recognition process on the revised contours.

Aspects of the present disclosure can include a method for an object recognition system, which can include detecting contours from data measurements of one or more objects provided by one or more vision sensors; detecting concavities of the contours of the one or more objects; evaluating a quality of each of the contours based on associated ones of the concavities; executing an object recognition process on the contours; and executing an action for each recognized object from the execution of the object recognition based on the quality of ones of the contours associated with the recognized object, the action selected from one of assign for pick-up by a robot or apply slight displacement motion by a robot.

Aspects of the present disclosure can include a computer program for an object recognition system, which can include instructions involving detecting contours from data measurements of one or more objects provided by one or more vision sensors; detecting concavities of the contours of the one or more objects; evaluating a quality of each of the contours based on associated ones of the concavities; executing an object recognition process on the contours; and executing an action for each recognized object from the execution of the object recognition based on the quality of ones of the contours associated with the recognized object, the action selected from one of assign for pick-up by a robot or apply slight displacement motion by a robot. The computer program and instructions can be stored on a non-transitory computer readable medium and executed by one or more processors.

Aspects of the present disclosure can include an object recognition system, which can include means for detecting contours from data measurements of one or more objects provided by one or more vision sensors; means for detecting concavities of the contours of the one or more objects; means for evaluating a quality of each of the contours based on associated ones of the concavities; means for executing an object recognition process on the contours; and means for executing an action for each recognized object from the execution of the object recognition based on the quality of ones of the contours associated with the recognized object, the action selected from one of assign for pick-up by a robot or apply slight displacement motion by a robot.

Aspects of the present disclosure can include an apparatus for an object recognition system, which can include a processor, configured to detect contours from data measurements of one or more objects provided by one or more vision sensors; detect concavities of the contours of the one or more objects; evaluate a quality of each of the contours based on associated ones of the concavities; execute an object recognition process on the contours; and execute an action for each recognized object from the execution of the object recognition based on the quality of ones of the contours associated with the recognized object, the action selected from one of assign for pick-up by a robot or apply slight displacement motion by a robot.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates examples of detected contours.

FIG. 2 illustrates the pixel level accuracy between the detected contour and the ground truth.

FIG. 3 is an example of modifying the contour by completing the incomplete line.

FIGS. 4(a) and 4(b) illustrate the two difficult recognition situations that can be addressed by applying the Slight Displacement technique.

FIGS. 5(a) and 5(b) illustrate example flowcharts of the two different minimum configurations of the proposed object recognition system, in accordance with example implementations.

FIG. 6 are examples of a convex object and a concave object.

FIG. 7 illustrates the contour with multiple concavities and its convex hull.

FIG. 8 is an example of a contour with multiple concavities and its bounding rectangle.

FIG. 9 illustrates the removal of the concavity when there are differences among the detected contours.

FIG. 10 illustrates the completion of the concavity when all contours contain the concavity.

FIG. 11 is an example of concavity completion.

FIG. 12 is an example of concavity removal.

FIG. 13 are examples of contours from three classes of objects with different r.

FIG. 14 illustrates a plurality of robots configured to execute object recognition in accordance to the example implementations described herein.

FIG. 15 illustrates an example computing environment with an example computer device suitable for use in some example implementations.

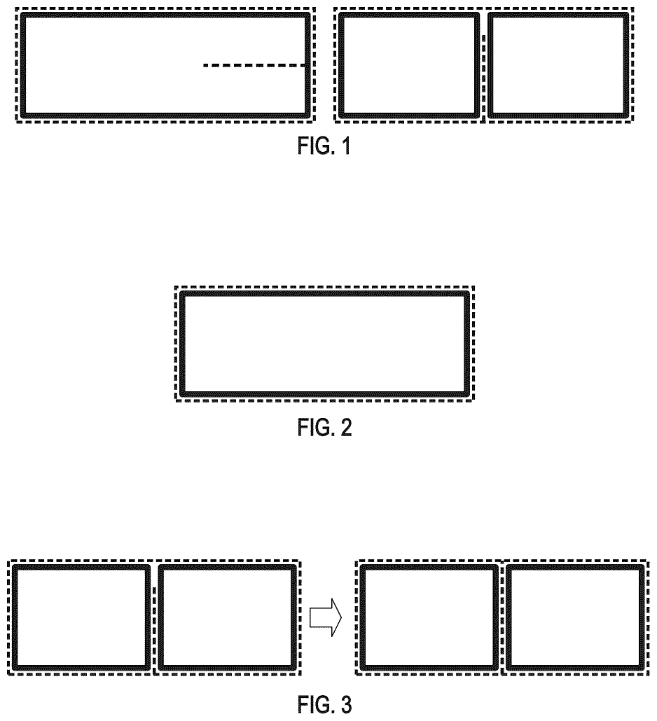

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

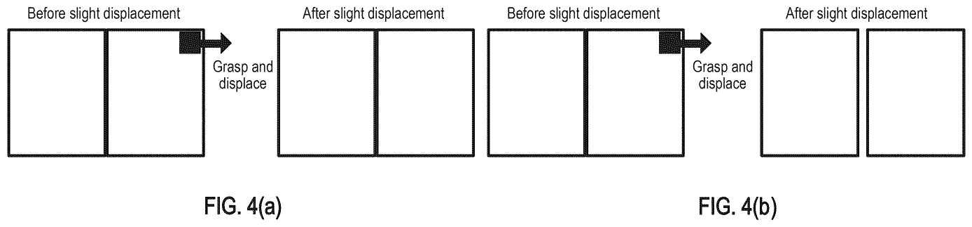

FIGS. 4(a) and 4(b) illustrate the two difficult recognition situations that can be addressed by applying the Slight Displacement technique. Sometimes, it can be difficult to determine if one detected object block would be one single object with lines traversing from one end to the other (FIG. 4(a)), or multiple objects tightly contacting each other (FIG. 4(b)). When using Slight Displacement, the robot grasps a corner area of such an object block and slightly displaces it to make object boundaries clear.

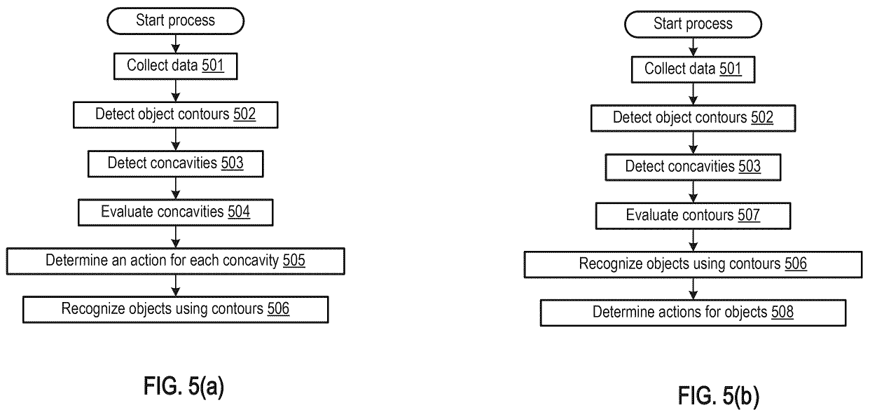

FIGS. 5(a) and 5(b) illustrate example flowcharts of the two different minimum configurations of the proposed object recognition system, in accordance with example implementations.

At 501, a component collects the data to be used in object recognition functions. The data could be but not limited to Red Green Blue (RGB) images, grayscale images, depth images, point clouds, and so on.

At 502, the collected data is used to detect the object contours. A variety of methods can be used, such as rule-based object recognition and learning-based object boundary detection. Other methods can be used in accordance with the desired implementation, and the present disclosure is not limited thereto.

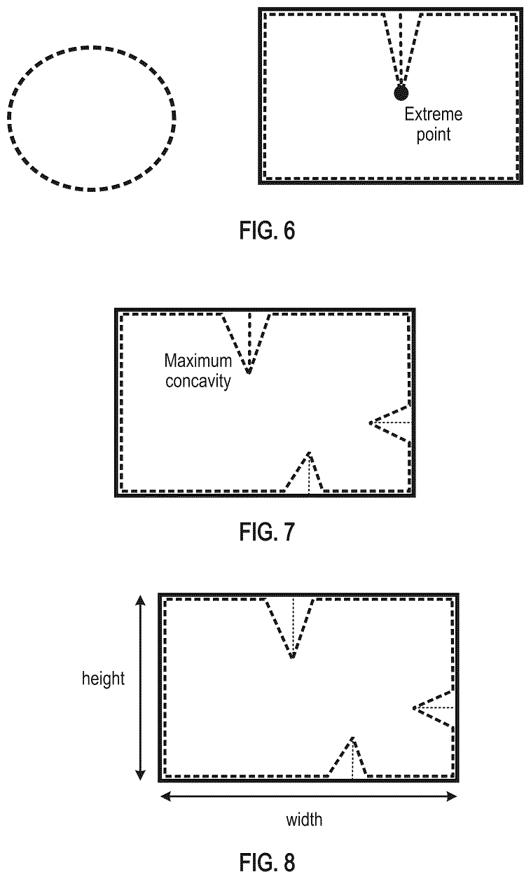

At 503, a component detects the concavities of the contours from the detected object contours from 502. Many methods exist for concavity detection, and any such method can be used in accordance with the desired implementation. Examples of convex and concave objects are shown in FIG. 6. Concave shapes could have convex hulls. Each concavity can be measured by the distance from the extreme point of the concavity to its convex hull. An example is shown in FIG. 6. FIG. 6 illustrates examples of a convex object (left) and a concave object (right, dash line). The concave object has a convex hull (black solid line). The concavity can be measured by the shortest distance (dash) from the extreme point of the concavity to the convex hull.

A detected contour from 502 could have multiple concavities, as shown in FIG. 7. The maximum concavity of a contour is the concavity that has the largest distance from the extreme point to the convex hull. The average and median concavity for each contour can also be calculated. FIG. 7 illustrates a contour (dash line) with multiple concavities and its convex hull (black solid line).

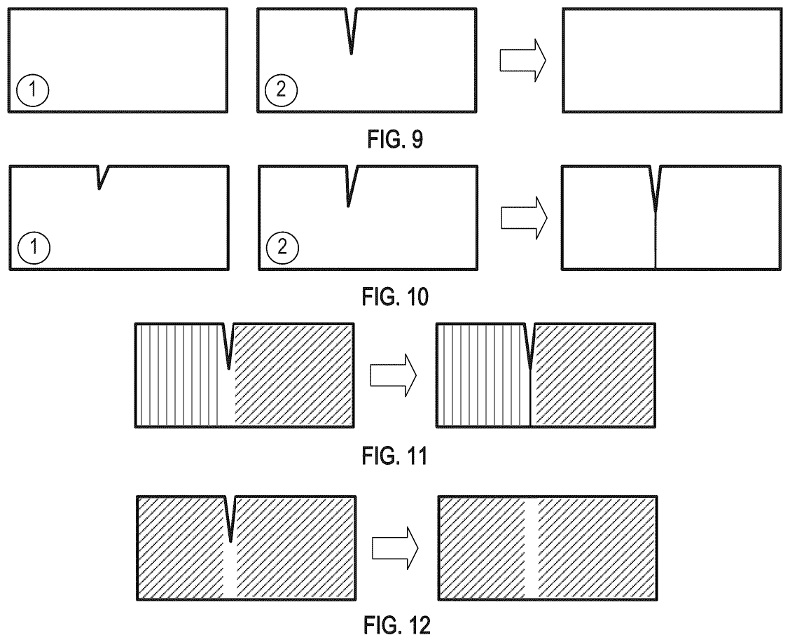

At 504, the component evaluates the correctness of concavities detected at 503. The correctness can be evaluated under different criteria. Example implementations described herein can involve two criteria as follows, among which one or both can be used for evaluation. If the distance from the extreme point of the concavity to the contour's convex hull exceeds a preset threshold, then the concavity is considered to be incorrect. Another is the concavity ratio: the ratio of the concavity and the side length (width or height) of the bounding rectangle, as shown in FIG. 8. If the ratio is greater than a preset threshold, then the concavity is considered to be incorrect. FIG. 8 illustrates a contour (dashed line) with multiple concavities and its bounding rectangle (black solid line).

At 505, the component determines an action for each concavity of a contour based on the evaluated correctness of the concavity determined at 504. When the concavity is evaluated as correct using the criteria proposed in 504 or any other customized criteria, the concavity is kept. When the concavity is evaluated as incorrect using the criteria proposed at 504 or any other customized criteria, whether to remove a concavity is determined as follows. If the concavity is longer than a preset threshold, the concavity is completed (extended to intersect with the convex hull). If for the same object, multiple contours are detected and combined to obtain the final object contour, for example, by using multiple sets of parameters or multiple detection methods as follows.

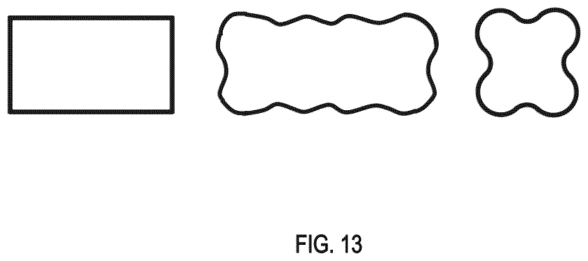

If there are differences among the detected contours on the concavity, the concavity is removed, as shown in FIG. 9. As shown at FIG. 9, the left and middle image are two detected contours of the same object. The concavity can be considered redundant and removed due to differences between the two contours on the concavity.

If all contours contain the concavity, the concavity is completed (extended to intersect with the convex hull), as shown in FIG. 10. As shown in FIG. 10, the left and middle image involve two detected contours of the same object. Both contours contain the concavity. The concavity is completed (extended to intersect with the convex hull), indicated by the grey line segment in the image on the right.

If depth information (distance between object and the sensor) is available, then check the depth difference in the neighborhood of the concavity. If the height difference exceeds the tolerance, the concavity is completed (extended to intersect with the convex hull). Otherwise, the concavity is considered redundant and removed. Examples are provided in FIG. 11 and FIG. 12. In the example of FIG. 11, on the left the depths are different (indicated by the pattern difference) on the two sides of the concavity, indicating two objects in this region. The concavity is completed (gray line segment) to generate two separate contours on the right. In FIG. 11, the contour on the left contains two objects, reflected by the depth difference between the two areas. Thus, the concavity reflects the boundary between these two objects. The concavity is determined to be completed to obtain the correct contours. On the other hand, the contour in FIG. 12 has no difference in the depth, indicating the contour belongs to one single object. Thus, the concavity is determined as redundant information and removed. Thus, in FIG. 12, on the left, the depths on the two sides of the concavity are similar, indicating only one object in this contour. The concavity is considered redundant and removed.

At 506, the component recognizes objects in the image using the detected contours. Examples of such methods include the flood fill algorithm and point cloud segmentation. Other methods can also be utilized in accordance with the desired implementation.

At 507, the component evaluates the quality of contours using concavities detected at 503. Example implementations can involve the following criteria, among which one or all can be used for evaluation. If the number of concavities on a contour exceeds a preset threshold, the contour is considered low quality. If the average or median concavity exceeds a preset threshold, the contour is considered low quality. If the maximum concavity exceeds a preset threshold, the contour is considered low quality.

At 508, the component determines at least one action for each recognized object from 506 based on the quality of the contour estimated in 507. The actions include at least one of the following: direct pick-up, slight displacement, or update the statistics of the recognition. For example, for each object, the object is assigned to be directly picked by a robot if at least one of the following is true: the detected concavities on the object contour are to be kept, or the object contour is evaluated as having high quality. The object is assigned to be applied slight displacement motion by a robot if at least one of the follows is true, at least one concavity is detected and considered to be either completed or removed, or the object contour is evaluated to have low quality.

The statistics of the recognition are updated based on the requirement of the application. For example, the number of objects with high quality contours is updated, and for each object with low quality contour, the average, median, and maximum concavity and the number of concavities are saved.

Through the example implementations described herein, it is possible to evaluate the correctness of detected concavities using simple geometric measures. Further, object recognition accuracy can be improved by identifying and modifying incorrect object contours. In addition, the example implementations can be integrated with many contour detection techniques to improve the contour.

The example implementations can also be used to determine robot actions for the recognized objects when the recognition software is integrated with a robotic system.

In another example implementation, the concavities of contours are used to classify objects into known classes. FIG. 13 illustrates examples of contours from three classes of objects with different r. From left to right, this includes cartons, paper rolls, and wrapped bottles. For objects that have straight contours, the concavities should be smaller comparing to objects that have curvy contours. The ratio between the average concavity and the median concavity of a contour is proposed as one criterion for object classification:

$$r = \frac{average concavity}{median concavity}$$

When r is large, for example, greater than a threshold a, one can determine that several large concavities exist, indicating the contour could have several locations with high curvatures. The objects might belong to shrink-wrapped bottles.
When r is within a range, for example, [β, α], one can determine that the contour has small curvatures. The objects might belong to paper rolls.
When r is close to 1, one can determine that the contour is close to a polygon. The objects might belong to cartons.

Optionally, the object classification results can be used in at least one of the following purposes.

Evaluate the correctness of concavities: one concavity is considered incorrect if at least one of the following is true: the size of the concavity is not in a predefined range for the object class, the location of the concavity does not comply with the known pattern of the object class, or the distances between the concavity and its neighbor concavities are not in a predefined range for the object class.

Optionally, at least one of the following actions can be determined based on the evaluated correctness of the concavities: incorrect concavities are removed, or correct concavities are kept.

The process can also be used to evaluate the quality of contours. One contour is considered low quality if at least one of the following is true: at least one concavity on the contour is incorrect based on the object class information, or the distribution of the concavities on the contour does not align with the known distribution pattern of the object class.

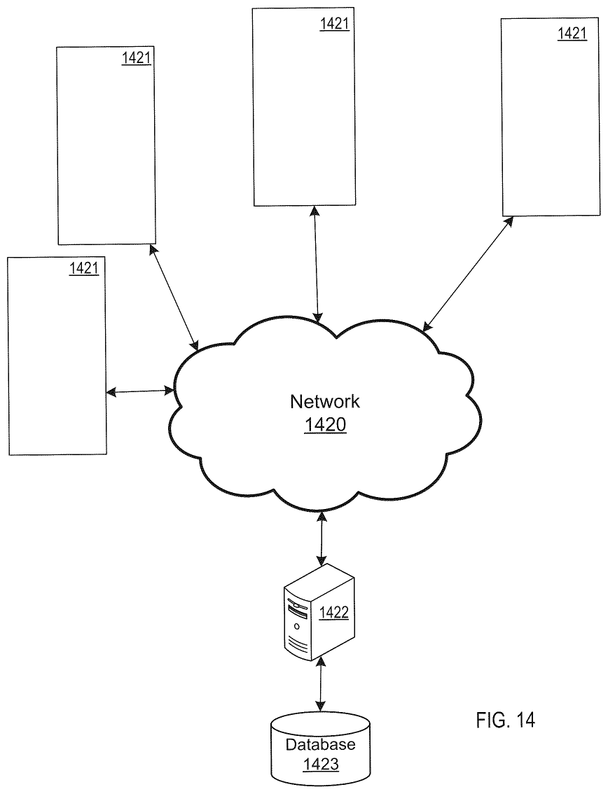

FIG. 14 illustrates a plurality of robots configured to execute object recognition in accordance to the example implementations described herein. One or more robots 1421 are configured to execute computer vision (e.g., picking robots) that are communicatively coupled to a network 1420 (e.g., local area network (LAN), wide area network (WAN)) through the corresponding network interface of the sensor system installed in the robots 1421, which is connected to a management apparatus 1422 configured to facilitate the functionality for the object recognition. The one or more robots 1421 may be associated with sensors or other data collecting mechanisms, depending on the desired implementation. The management apparatus 1422 manages a database 1423, which contains historical data collected from the sensor systems or data collecting mechanisms from each of the robots 1421. In alternate example implementations, the data from the sensor systems of the robots 1421 can be stored in a central repository or central database such as proprietary databases that intake data from the robots 1421, or systems such as enterprise resource planning systems, and the management apparatus 1422 can access or retrieve the data from the central repository or central database. The sensor systems of the robots 1421 can include any type of sensors to facilitate the desired implementation and provide internal status machine data, such as but not limited to gyroscopes, accelerometers, vision sensors (e.g., cameras, depth cameras, infrared sensors, and so on), global positioning satellite (GPS), thermometers, humidity gauges, or any sensors, and so on. As described herein, the management apparatus 1422 can also be connected to one or more cameras (not illustrated) that are monitoring the external status of the one or more robots 1421.

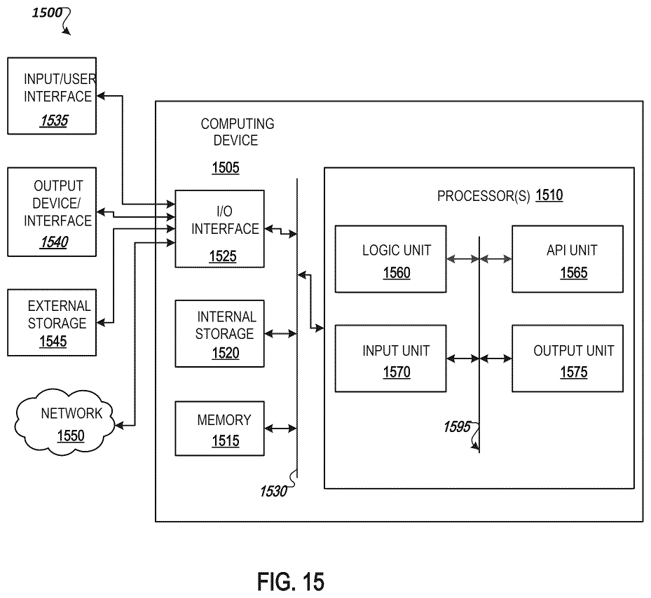

FIG. 15 illustrates an example computing environment with an example computer device suitable for use in some example implementations, such as the management apparatus 1422 to facilitate the functionality of each robot. Computer device 1505 in computing environment 1500 can include one or more processing units, cores, or processors 1510, memory 1515 (e.g., RAM, ROM, and/or the like), internal storage 1520 (e.g., magnetic, optical, solid state storage, and/or organic), and/or I/O interface 1525, any of which can be coupled on a communication mechanism or bus 1530 for communicating information or embedded in the computer device 1505. I/O interface 1525 is also configured to receive images from cameras or provide images to projectors or displays, depending on the desired implementation.

Computer device 1505 can be communicatively coupled to input/user interface 1535 and output device/interface 1540. Either one or both of input/user interface 1535 and output device/interface 1540 can be a wired or wireless interface and can be detachable. Input/user interface 1535 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1540 may include a display, television, monitor, printer, speaker, braille, or the like. In some example implementations, input/user interface 1535 and output device/interface 1540 can be embedded with or physically coupled to the computer device 1505. In other example implementations, other computer devices may function as or provide the functions of input/user interface 1535 and output device/interface 1540 for a computer device 1505.

Examples of computer device 1505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1505 can be communicatively coupled (e.g., via I/O interface 1525) to external storage 1545 and network 1550 for communicating with any number of networked components, devices, and systems, including one or more computer devices of the same or different configuration. Computer device 1505 or any connected computer device can be functioning as, providing services of, or referred to as a server, client, thin server, general machine, special-purpose machine, or another label.

I/O interface 1525 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1500. Network 1550 can be any network or combination of networks (e.g., the Internet, local area network, wide area network, a telephonic network, a cellular network, satellite network, and the like).

Computer device 1505 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1505 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1510 can execute under any operating system (OS) (not shown), in a native or virtual environment. One or more applications can be deployed that include logic unit 1560, application programming interface (API) unit 1565, input unit 1570, output unit 1575, and inter-unit communication mechanism 1595 for the different units to communicate with each other, with the OS, and with other applications (not shown). The described units and elements can be varied in design, function, configuration, or implementation and are not limited to the descriptions provided. Processor(s) 1510 can be in the form of hardware processors such as central processing units (CPUs) or in a combination of hardware and software units.

In some example implementations, when information or an execution instruction is received by API unit 1565, it may be communicated to one or more other units (e.g., logic unit 1560, input unit 1570, output unit 1575). In some instances, logic unit 1560 may be configured to control the information flow among the units and direct the services provided by API unit 1565, input unit 1570, output unit 1575, in some example implementations described above. For example, the flow of one or more processes or implementations may be controlled by logic unit 1560 alone or in conjunction with API unit 1565. The input unit 1570 may be configured to obtain input for the calculations described in the example implementations, and the output unit 1575 may be configured to provide output based on the calculations described in example implementations.

Processor(s) 1510 can be configured to execute methods or computer instructions for an object recognition system, which can include detecting contours from data measurements of one or more objects provided by one or more vision sensors (501); detecting concavities of the contours of the one or more objects (503); evaluating correctness of each of the concavities (504); executing an action for the each of the concavities based on the evaluated correctness to produce revised contours, the action selected from one of keep, complete, or remove (505); and executing an object recognition process on the revised contours (506) as shown in FIG. 5(a).

Processor(s) 1510 can be configured to execute methods or computer instructions as described herein, wherein the evaluating the correctness of the each of the concavities is based on a distance between an extreme point of the each of the concavities and a convex hull of the contour exceeding a threshold as illustrated and described with respect to FIG. 7.

Processor(s) 1510 can be configured to execute methods or computer instructions as described herein, wherein the evaluating the correctness of the each of the concavities is based on a ratio of the each of the concavity to a side length of a bounding rectangle of an associated contour exceeding a threshold as illustrated and described with respect to FIG. 8.

Processor(s) 1510 can be configured to execute methods or computer instructions as described herein, wherein complete is selected as the action when each of the concavities is longer than a preset threshold and evaluated as incorrect as described with respect to 505 of FIG. 5(a).

Processor(s) 1510 can be configured to execute methods or computer instructions as described herein, wherein complete is selected as the action for the each of the concavity evaluated as incorrect when depth information between the one or more objects and the one or more vision sensors indicates that a depth difference in an area proximate to the each of the concavities exceeds a threshold as illustrated and described with respect to FIG. 11; and wherein remove is selected as the action for the each of the concavities evaluated as incorrect when the depth difference does not exceed the threshold as illustrated and described with respect to FIG. 12.

Processor(s) 1510 can be configured to execute methods or computer instructions as described herein, wherein remove is selected as the action for the each of the concavities evaluated as incorrect when the each of the concavity associated with a first contour of an object causes a difference between the first contour of the object from the one or more objects and a second contour associated with the object from the one or more objects as described and illustrated with respect to FIG. 9; wherein complete is selected as the action for the each of the concavities evaluated as incorrect when the each of the concavity associated with the first contour also occurs in the second contour as described and illustrated with respect to FIG. 10.

Processor(s) 1510 can be configured to execute methods or computer instructions for an object recognition system, which can include detecting contours from data measurements of one or more objects provided by one or more vision sensors (502); detecting concavities of the contours of the one or more objects (503); evaluating a quality of each of the contours based on associated ones of the concavities (507); executing an object recognition process on the contours (506); and executing an action for each recognized object from the execution of the object recognition based on the quality of ones of the contours associated with the recognized object, the action selected from one of assign for pick-up by a robot or apply slight displacement motion by a robot (508).

Processor(s) 1510 can be configured to execute methods or computer instructions as described herein, wherein the evaluating the quality of the each of the contours is based on a number of concavities for the each of the contours exceeding a threshold as described with respect to 507.

Processor(s) 1510 can be configured to execute methods or computer instructions as described herein, wherein the evaluating the quality of the each of the contours is based on an average or median concavity of the each of the contours exceeding a threshold. In such an example implementation, the average or median concavity refers to the average or median distance between the concavity extreme points and the convex hull of the contour that these concavities belong to. Contours can be considered low quality (or quality below a threshold) if the average or median concavity exceeds a threshold, because in this case most concavities of this contour might be very large and this contour might be very wavy.

Processor(s) 1510 can be configured to execute methods or computer instructions as described herein, wherein the evaluating the quality of the each of the contours is based on maximum concavity of the each of the contours exceeding a threshold as described with respect to FIG. 7. Maximum concavity is the concavity that has the largest distance between the concavity extreme point and the contour that the concavity belongs to. Contours can be considered as low quality if the maximum concavity exceeds a threshold (because in this case the contour might have a huge defect), and high quality otherwise.

Processor(s) 1510 can be configured to execute methods or instructions as described herein, wherein the assign for pick-up by the robot is selected as the action when an associated contour of the recognized object is evaluated as having the quality above a threshold, or for when detected concavities on the associated contour are maintained as described with respect to 508.

Processor(s) 1510 can be configured to execute the method or instructions as described herein, wherein the apply slight displacement motion by a robot is selected as the action for when an associated contour of the recognized object is evaluated as having a quality below a threshold, or for when at least one concavity is completed or removed from the associated contour as described with respect to 508.

Processor(s) 1510 can be configured to execute the method or instructions as described herein, and further involve updating statistics for the object recognition process based on one or more of a number of the one or more objects having the quality exceeding a threshold, an average concavity of the one or more objects having the quality lower than the threshold, a median concavity of the one or more objects having the quality lower than the threshold, and a maximum concavity of the one or more objects having the quality lower than the threshold as described with respect to 508.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for an object recognition system, comprising:
detecting contours from data measurements of one or more objects provided by one or more vision sensors;
detecting concavities of the contours of the one or more objects;
evaluating correctness of each of the concavities;
executing an action for the each of the concavities based on the evaluated correctness to produce revised contours, the action selected from one of keep, complete, or remove; and
executing an object recognition process on the revised contours.

2. The method of claim 1, wherein the evaluating the correctness of the each of the concavities is based on a distance between an extreme point of the each of the concavities and a convex hull of the contour exceeding a threshold.

3. The method of claim 1, wherein the evaluating the correctness of the each of the concavities is based on a ratio of the each of the concavity to a side length of a bounding rectangle of an associated contour exceeding a threshold.

4. The method of claim 1, wherein complete is selected as the action when each of the concavities is longer than a preset threshold and evaluated as incorrect.

5. The method of claim 1, wherein complete is selected as the action for the each of the concavity evaluated as incorrect when depth information between the one or more objects and the one or more vision sensors indicates that a depth difference in an area proximate to the each of the concavities exceeds a threshold; and
wherein remove is selected as the action for the each of the concavities evaluated as incorrect when the depth difference does not exceed the threshold.

6. The method of claim 1, wherein remove is selected as the action for the each of the concavities evaluated as incorrect when the each of the concavity associated with a first contour of an object causes a difference between the first contour of the object from the one or more objects and a second contour associated with the object from the one or more objects;
wherein complete is selected as the action for the each of the concavities evaluated as incorrect when the each of the concavity associated with the first contour also occurs in the second contour.

7. A method for an object recognition system, comprising:
detecting contours from data measurements of one or more objects provided by one or more vision sensors;
detecting concavities of the contours of the one or more objects;
evaluating a quality of each of the contours based on associated ones of the concavities;
executing an object recognition process on the contours; and
executing an action for each recognized object from the execution of the object recognition based on the quality of ones of the contours associated with the recognized object, the action selected from one of assign for pick-up by a robot or apply slight displacement motion by the robot.

8. The method of claim 7, wherein the evaluating the quality of the each of the contours is based on a number of concavities for the each of the contours exceeding a threshold.

9. The method of claim 7, wherein the evaluating the quality of the each of the contours is based on an average or median concavity of the each of the contours exceeding a threshold.

10. The method of claim 7, wherein the evaluating the quality of the each of the contours is based on maximum concavity of the each of the contours exceeding a threshold.

11. The method of claim 7, wherein the assign for pick-up by the robot is selected as the action when an associated contour of the recognized object is evaluated as having the quality above a threshold, or for when detected concavities on the associated contour are maintained.

12. The method of claim 7, wherein the apply slight displacement motion by the robot is selected as the action for when an associated contour of the recognized object is evaluated as having a quality below a threshold, or for when at least one concavity is completed or removed from the associated contour.

13. The method of claim 7, further comprising updating statistics for the object recognition process based on one or more of a number of the one or more objects having the quality exceeding a threshold, an average concavity of the one or more objects having the quality lower than the threshold, a median concavity of the one or more objects having the quality lower than the threshold, and a maximum concavity of the one or more objects having the quality lower than the threshold.

14. A non-transitory computer readable medium, storing instructions for an object recognition system, the instructions comprising:
detecting contours from data measurements of one or more objects provided by one or more vision sensors;
detecting concavities of the contours of the one or more objects;
evaluating correctness of each of the concavities;
executing an action for the each of the concavities based on the evaluated correctness to produce revised contours, the action selected from one of keep, complete, or remove; and
executing an object recognition process on the revised contours.

15. The non-transitory computer readable medium of claim 14, wherein the evaluating the correctness of the each of the concavities is based on a distance between an extreme point of the each of the concavities and a convex hull of the contour exceeding a threshold.

16. The non-transitory computer readable medium of claim 14, wherein the evaluating the correctness of the each of the concavities is based on a ratio of the each of the concavity to a side length of a bounding rectangle of an associated contour exceeding a threshold.

17. The non-transitory computer readable medium of claim 14, wherein complete is selected as the action when each of the concavities is longer than a preset threshold and evaluated as incorrect.

18. The non-transitory computer readable medium of claim 14, wherein complete is selected as the action for the each of the concavity evaluated as incorrect when depth information between the one or more objects and the one or more vision sensors indicates that a depth difference in an area proximate to the each of the concavities exceeds a threshold; and
wherein remove is selected as the action for the each of the concavities evaluated as incorrect when the depth difference does not exceed the threshold.

19. The non-transitory computer readable medium of claim 14, wherein remove is selected as the action for the each of the concavities evaluated as incorrect when the each of the concavity associated with a first contour of an object causes a difference between the first contour of the object from the one or more objects and a second contour associated with the object from the one or more objects;
wherein complete is selected as the action for the each of the concavities evaluated as incorrect when the each of the concavity associated with the first contour also occurs in the second contour.
